(19) United States
(12) Patent Application Publication
(10) Pub. No.: US 2022/0169427 A1
(43) Pub. Date: Jun. 2, 2022

(54) BOTTLE OR CONTAINER SEAL

(71) Applicant: Jeffrey Julian, Burbank, CA (US)

(72) Inventor: Jeffrey Julian, Burbank, CA (US)

(21) Appl. No.: 17/537,686

(22) Filed: Nov. 30, 2021

Related U.S. Application Data
(60) Provisional application No. 63/119,911, filed on Dec. 1, 2020.

(51) Int. Cl. B65D 51/22

(52) U.S. Cl. CPC B65D 51/22; B65D 2577/205; B65D 2251/0093

(57) ABSTRACT

A seal for a bottle or container that provides a purchase that eases the removal of the seal. In certain embodiments, a first section of the seal is sized to generally match the shape of the top of the bottle or container and a second section of the seal is attached to the first section to provide a purchase for removing the seal. In certain embodiments, additional sections may be attached to the second section.

### CROSS-REFERENCE TO RELATED APPLICATION

This application claims the benefit of U.S. Provisional Application No. 63/119,911, filed on Dec. 1, 2020, entitled “Bottle or Container Seal” which is incorporated herein by reference in its entirety.

### TECHNICAL FIELD

The present invention relates generally to an easy to open bottle or container seal.

### BACKGROUND AND SUMMARY

As is known in the art, bottles and other containers (including, but not limited to, pill bottles), often have a seal covering the top opening to help ensure freshness and help prevent tampering with the contents of the bottle. Some known seals provide a means to assist consumers in removing the seal, such as a small tab that extends beyond the rim of the container. In addition, as illustrated in FIG. 1, it is known to provide a half flap bisecting the seal that a consumer can pinch between the thumb and index finger to peel the seal back. These known seals, however, are often difficult for people to remove, especially older people.

Accordingly, it is an object of the present invention to provide a seal for bottles and other containers that are easier to remove.

### BRIEF DESCRIPTION OF THE DRAWINGS

FIG. 1 depicts a prior art bottle or container seal;

FIG. 2 depicts a bottle having a seal in accordance with an embodiment of the present invention;

FIG. 3 illustrates a seal in accordance with an embodiment of the present invention in a closed position;

FIG. 4 illustrates a seal in accordance with an embodiment of the present invention in the process of being opened;

FIGS. 5A-5C depict seals in accordance with embodiments of the present invention;

FIG. 6 depicts an embodiment of a bottle having a seal in accordance with an embodiment of the present invention having three sections.

In the figures, like numerals refer to like items.

### DETAILED DESCRIPTION

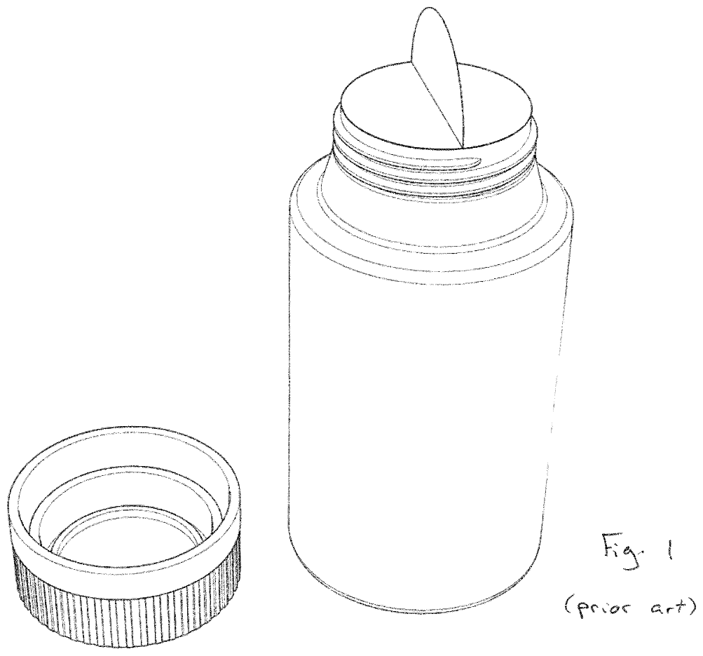

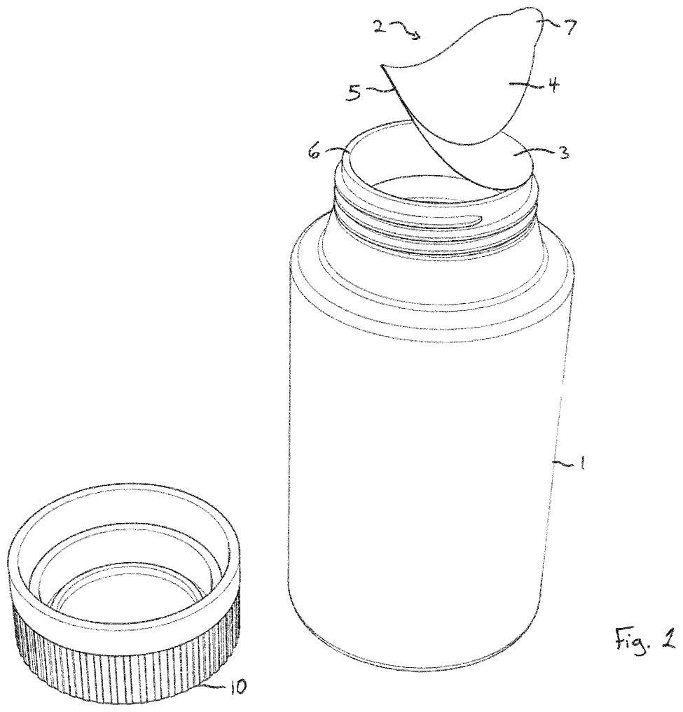

FIG. 2 depicts a bottle 1 having a seal 2 in accordance with an embodiment of the present invention. Seal 2 is shown in a partially opened state. In this embodiment, seal 2 is comprised of first section 3 and second section 4. First and second sections 3 and 4 are disk-shaped and are also generally sized to match the shape of the top 6 of bottle 1. Different shapes may, however, be used for second section 4, since only the first section 3 needs to cover the opening of bottle 1 to form a seal. In different embodiments, the shapes of the first and second sections 3 and 4 may vary depending on the shape of the top of the bottle or container and need not be disk-shaped. First section 3 may be attached to the top 6 of bottle 1 by an adhesive applied between first section 3 and the top 6 of bottle 1, or by other suitable attachment methods known in the art. First section 3 may be connected to second section 4 by a weld 5, as shown in FIG. 1. Alternatively, instead of welds, other techniques for attaching the sections of seal 2 may be used, such as, but not limited to, adhesives. Preferably, weld 5 provides a stronger connection between first section 3 and second section 4 than the connection between first section 3 and the top 6 of bottle 1. Second section 4 may include tab 7. In this embodiment, seal 2 is configured such that, when it is in a closed position, second section 4 lies on top of first section 3.

In an alternative embodiment, sections 3 and 4 may be formed from a unitary material and folded over one another, instead of connected by weld 5.

In FIG. 2, a bottle cap 10 for bottle 1 is shown next to bottle 1.

In operation, the top section 4 provides a large purchase by which a consumer can peel back first section 3 and thereby open seal 2.

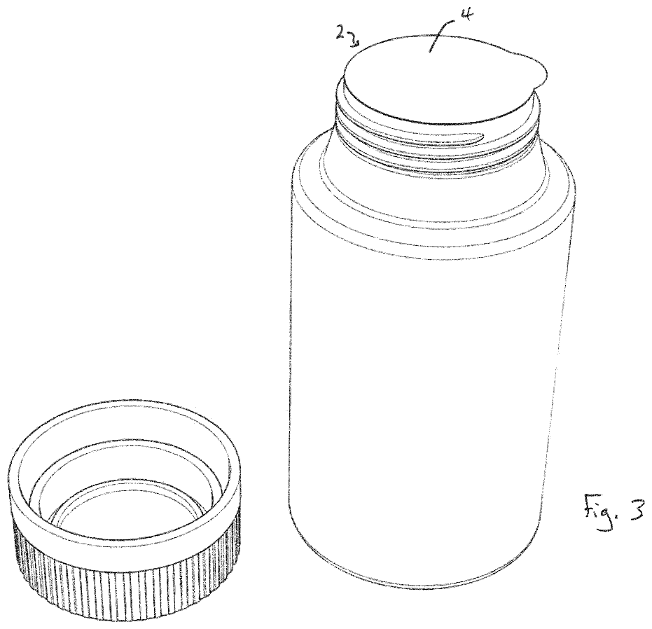

FIG. 3 illustrates seal 2 in a closed position in which first section 3 (not shown) is still attached to the top 6 of bottle 1 and second section 4 lies on top of first section 3.

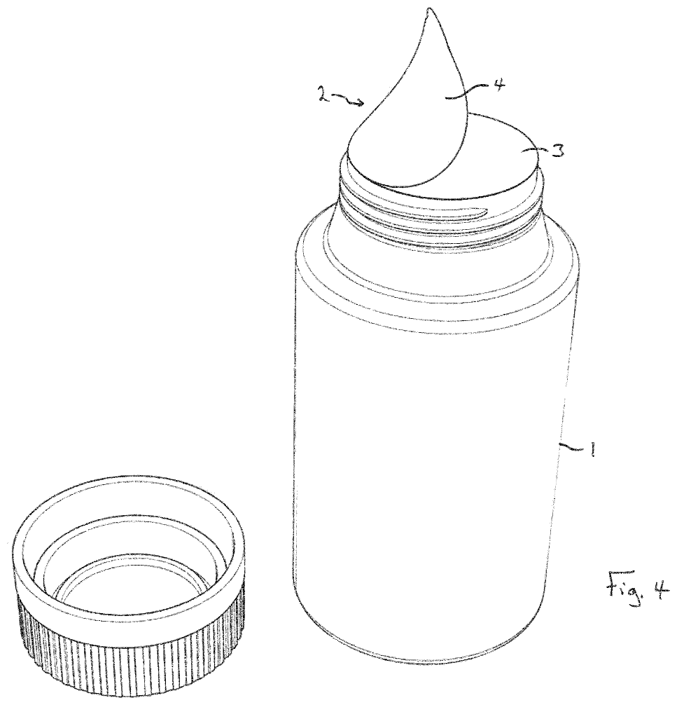

FIG. 4 illustrates seal 2 in the process of being opened, wherein first section 3 is still attached to the top 6 of bottle 1, while second section 4 is lifted apart from first section 3.

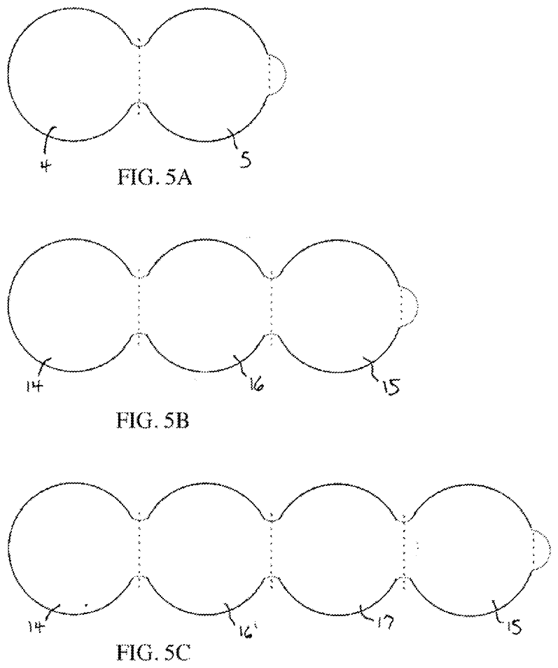

As shown in FIGS. 5A-5C, in other embodiments, additional seal sections may be added such that the sections may lie on top of each other in the same or similar manner illustrated in FIG. 2. For example, FIG. 5A shows a seal having two sections 4 and 5, as also shown in FIG. 1. FIG. 5B shows a seal having three sections 14, 15, 16. FIG. 5C shows a seal having four sections 14, 15, 16, 17.

In addition, in certain embodiments, information can be printed on one or both sides of the seal sections, such as seal sections 4 and 5 in FIG. 5A; seal sections 14, 15, 16 in FIG. 5B; and seal sections 14, 15, 16, 17 in FIG. 5C.

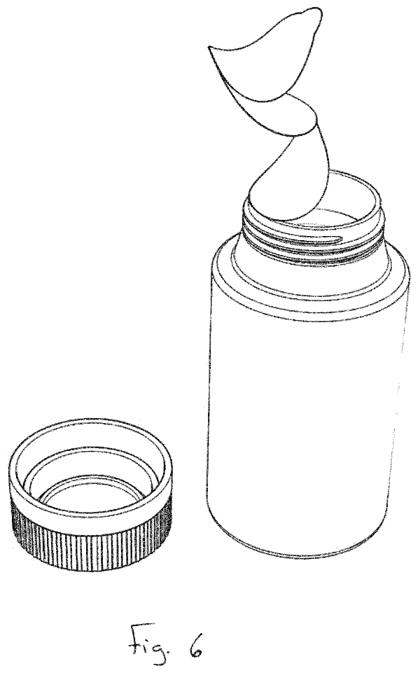

FIG. 6 depicts an embodiment of a bottle having a seal with three sections in accordance with an embodiment of the present invention, wherein the seal is in a partially opened position.

The illustrative descriptions of the principles of the present invention are to enable any person skilled in the art to make or use the disclosed invention. These descriptions are susceptible to numerous modifications and alternative arrangements by those skilled in the art. Such modifications and alternative arrangements are not intended to be outside the scope of the present invention. Thus, the present invention should not be limited to the described embodiments but, instead, is to be accorded the broadest scope consistent with the principles and novel features disclosed herein.

What is claimed is:

1. A seal for a container comprising:
at least a first section and a second section;
wherein, the first section is sized to cover an opening in the container and is capable of being affixed to the container over the opening; and
the second section is connected to an edge of the first section and is sized such that it provides a purchase for removing the first section from the container.

2. The seal of claim 1 wherein the first section is welded to the second section.

3. The seal of claim 1 wherein the first section and second section are connected by an adhesive.

4. The seal of claim 1 wherein the first section and second section are formed from a unitary material.

5. The seal claim 1 wherein the first section and second section have similar sizes.

6. The seal claim 1 wherein the first section and second section have different sizes.

7. The seal of claim 1 wherein the second section may be positioned to lie on top of the first section.

8. The seal of claim 1 comprising a third section connected to an edge of the second section.

9. The seal of claim 8 comprising one or more additional sections, wherein one of the additional sections is connected to the third section and the remaining sections, if any, are sequentially connected to one another.

10. The seal of claim 1 where printed information is provided on the first section and/or second section.
